(19) United States
(12) Patent Application Publication
(10) Pub. No.: US 2019/0240091 A1
(43) Pub. Date: Aug. 8, 2019

(54) TRANSFERABLE WHEELCHAIR WIDTH ADJUSTER

(71) Applicant: Ronald Dee Perkins, Durham, NC (US)

(72) Inventor: Ronald Dee Perkins, Durham, NC (US)

(21) Appl. No.: 15/891,015

(22) Filed: Feb. 7, 2018

(51) Int. Cl. A61G 5/08

(52) U.S. Cl. CPC A61G 5/0883; A61G 5/0825

(57) ABSTRACT

A transferable wheelchair width adjuster that can be attached to the lower frame of a folding wheelchair allowing the wheelchair to be narrowed to varying widths so as to accommodate entry through doorways that otherwise would be impassable. Narrowing the profile of a standard wheelchair also allows the chair to accommodate more comfortably a smaller individual, such as a small child. No modification of the original wheelchair construction is necessary. The width adjuster described herein can be attached and removed manually without the need of tools.

### BACKGROUND OF THE INVENTION

According to the National Institutes of Health, 2.2 million people in the United States depend on a wheelchair for day-to-day tasks and mobility. Many of these wheelchairs are those that fold in order to transport them from place to place. The width of a standard, manual, adult-sized wheelchair is 26 inches at the rear wheels. To meet ADA accessibility standard, doors should have a clear width of 32 inches from the face of the door to the opposite stop. Unfortunately in many homes and buildings, interior passage doors often measure 23 to 27 inches. Compounding the problem is the issue of a sharp or narrow turn necessary to fit through a door when entering from a hallway.

There have been many modifications to the folding wheelchair design invented by Everest and Jennings and patented in 1937. Their simple, but elegant design, connected rigid side frames with two diagonal braces in an “X-shaped” configuration, reminiscent of folding camp stools. This basic design is incorporated in most folding wheelchairs today with the diagonal braces commonly referred to as a cross brace, an x-brace, or a scissors brace.

A review of prior art cited in the patents referenced herein reveal several approaches that have been attempted to accomplish the narrowing of a folding wheelchair. Some have suggested methods to raise the side frames mechanically which compresses the arms of the cross brace thereby resulting in a narrowing of the wheelchair. Examples of patents that embody this approach include U.S. Pat. No. 2,641,306, Jun. 9, 1953 Lerman; U.S. Pat. No. 2,824,597, Feb. 25, 1958 Lerman; U.S. Pat. No.3,122,395, Feb. 25, 1964 Offner; U.S. Pat. No. 3,331,614, Jul. 18, 1967 McClintock; U.S. Pat. No. 4,500,109, Feb. 19, 1985 Volin; U.S. Pat. No. 4,648,615, Mar. 10, 1987 Volin; U.S. Pat. No. 4,802,263, Feb. 7, 1989 Gillum, Sr.

Virtually all of these mechanical means require modification of the original chair and become an integral part of the chair. Such attached devices are not easily transferable to other wheelchairs and may require considerable strength to operate. Several of these may restrict the lateral movement of the patient's arms making it difficult to turn the wheels by hand.

A related approach that has been proposed involves a mechanical means to pull the uppermost part of the frames together using a turnbuckle or threaded device thereby narrowing the wheelchair width. Examples of patents suggesting this approach include U.S. Pat. No. 4,264,085, Apr. 28, 1981Volin and U.S. Pat. No. 4,553,770, Nov. 19, 1985 Lyman. Such an approach involves installation and adjustment of a mechanical device by the user and are not easily transferable to another wheelchair. Such installations may also interfere with the seat sling when the chair is narrowed.

Another approach that results in narrowing the width of the wheelchair is to shorten the length of the cross brace arms which brings the side frames inward. Several patents cited allow adjustment of the arms to varying lengths resulting in a variety of widths possible. A snap button assembly is often utilized to lengthen or shorten the arms of the cross brace. Examples of patents that incorporate this method to narrow the width of a wheelchair include: U.S. Pat. No. 2,669,289, Feb. 16, 1954 Usher et al.; U.S. Pat. No. 4,082,348, Apr. 4, 1978 Haury; U.S. Pat. No. 4,813,693, Mar. 21, 1989 Lockard et al.; U.S. Pat. No. 4,989,890, Feb. 5, 1991 Lockard et al.; Foreign Pat. No. EP 0 904 760 A1, Mar. 31, 1999, Horacek ; U.S. Pat. No. 5,954,402, Sep. 21, 1999 Mcinturff; U.S. Pat. No. 6,050,582, Apr. 18, 2000 Horacek; Foreign Pat. No. EP 1 920 746 A2, May 14, 2008 Bates. Adjustable cross braces produced during the manufacturing of this type of folding wheelchair add significantly to the cost when compared to a standard folding wheelchair. The adjustable cross brace arms are an integral component of the manufactured wheelchair and are not transferable to another wheelchair.

Another approach to narrowing the width of a wheelchair involves replacing the traditional vertical orientation of the cross brace with a horizontal cross brace. Examples of such an approach include: U.S. Pat. No. 5,782,483, Jul. 21, 1998 Rogers et al.; U.S. Pat. No. 6,164,674, Dec. 26, 2000 Rogers et al.; U.S. Pat. No.8,454,048 B1, Jun. 4, 2013 Regan et al.; U.S. Pat. No. 9,655,794 B2, May 23, 2017 Bednarz, Ill et al.

Construction of such wheelchairs appears to be more complex and costly to manufacture and do not appear to be widely accepted when compared to the traditional folding wheelchair.

The approach proposed within this application is to provide a relatively inexpensive, width adjusting device that can be manually added or removed from a folding wheelchair without the use of tools and is transferable from one chair to another.

### BRIEF SUMMARY OF THE INVENTION

The primary purpose of narrowing the width of a folding wheelchair is to allow a patient to enter a room through a doorway that is too narrow to permit passage when the chair is fully opened. Another useful application of narrowing the width of a wheelchair is to more comfortably accommodate a small or frail adult or a child while seated in the sling seat. An additional benefit of using the described wheelchair adjusting device is that it strengthens the wheelchair by serving as a lateral brace that partially relieves the pressure exerted by the weight of a patient while seated on the sling seat.

The invention proposed herein pertains to adjusting the width of a folding wheelchair without modifying the structure of the wheelchair. The proposed device allows adjustment of a wheelchair's width to varying lengths and can be attached to the folding wheelchair manually without the aid of tools. Furthermore, the device is transferable from one wheelchair to another with ease. The device is compact, portable and can be manufactured from steel, aluminum, or high-impact plastic. As such the device is relatively inexpensive to manufacture as there are several manufacturers that already produce the necessary components that could be incorporated in the production of this adjusting device.

Most previous proposals to address the issue of narrowing a wheelchair so that it may pass through more narrow doors require complex manufacturing or the addition of mechanical devices that must be installed with tools. Such modifications generally are not transferable to another wheelchair without a great deal of effort. The proposed invention is installed by simply raising the sling seat of a wheelchair until the chair is at the desired width, at which time the device is manually adjusted to the desired width and slipped in place (compare FIG. 12 with FIG. 13.).

U.S. CI. CPC # FIELD OF CLASSIFICATION SEARCH (2017 August)
A61G transport or accommodation for patients; operating tables or chairs; chairs for dentistry; funeral devices
A61G 5/00 chairs or personal conveyances specifically adapted for patients or disabled persons, e.g. wheelchairs
A61G 5/02 propelled by the patient or disabled person
A61G 5/08 foldable
A61G 5/0816 folding side to side, e.g. reducing or expanding the overall width of the wheelchair
A61G 5/0825 comprising a scissor type frame, e.g. having pivoting crossbars for enabling folding
A61G 5/1062 adjusting width of the seat

### REFERENCES CITED IN THE FILE OF THIS PATENT UNITED STATES PATENTS

| | | |
|---|---|---|
| 2,095,411 | Everest et al. | Oct. 12, 1937 |
| 2,641,306 | Lerman | Jun. 9, 1953 |
| 2,669,289 | Usher et al. | Feb. 16, 1954 |
| 2,824,597 | Lerman | Feb. 25, 1958 |
| 3,122,395 | Offner | Feb. 25, 1964 |
| 3,331,614 | McClintock | Jul. 18, 1967 |
| 3,937,490 | Nsar | Feb. 10, 1976 |
| 4,082,348 | Haury | Apr. 4, 1978 |
| 4,264,085 | Volin | Apr. 28, 1981 |
| 4,500,109 | Volin | Feb. 19, 1985 |
| 4,553,770 | Lyman | Nov. 19, 1985 |
| 4,648,615 | Volin | Mar. 10, 1987 |
| 4,802,683 | Gillum | Feb. 7, 1989 |
| 4,813,693 | Lockard et al. | Mar. 21, 1989 |
| 4,989,890 | Lockard et al. | Feb. 5, 1991 |
| 5,328,183 | Counts | Jul. 12, 1994 |
| 5,497,926 | Rittenhouse | Mar. 12, 1996 |
| 5,667,235 | Pearce et al. | Sep. 16, 1997 |
| 5,782,483 | Rogers et al. | Jul. 21, 1998 |
| 5,915,709 | Radjenovic et al. | Jun. 29, 1999 |
| 5,954,402 | McInturff | Sep. 21, 1999 |
| 6,050,582 | Horacek | Apr. 18, 2000 |
| 6,164,674 | Rogers et al. | Dec. 26, 2000 |
| 6,264,218 | Slagerman | Jul. 24, 2001 |
| 6,352,307B1 | Engman | Mar. 5, 2002 |
| 8,454,048 | Regan et al. | Jun. 4, 2013 |
| 9,655,794B2 | Bednarz, III et al. | May 23, 2017 |

### FOREIGN PATENTS

| | | |
|---|---|---|
| EP 904 760 A1 | Horacek | Mar. 31, 1999 |
| EP 1920 746 A2 | Bates | May 14, 2008 |
| EP 2 156 814 A1 | Nicolas et al. | Feb. 24, 2010 |
| CN101828996 | Wang | May 26, 2010 |

### OTHER REFERENCES CITED

Dr. D. Michael McKeough, 2007, Anatomy of a Manual Wheelchair, Department of Physical Therapy, Sacramento State University, 36 p.
http://www.wheelchairnet.org/WCN_WCU/SlideLectures/McKeough/MckeoughWCAnat.html
National Institute of Health: Number of people in US using wheelchairs https://www.nichd.nih.gov/health/topics/rehabtech/conditioninfo/people
American Disability Act with respect to door width requirements: https://adata.org/factsheet/opening-doors-everyone

### BRIEF DESCRIPTION OF THE DRAWINGS

FIG. 1 is a perspective view showing primary components of a standard folding wheelchair.

FIG. 2 is a perspective view of a folding wheelchair with the wheelchair frame shaded for reference.

FIG. 3 is a perspective view of a folding wheelchair with the wheelchair cross brace shaded for reference.

FIG. 4 is a side view of the assembled wheel chair adjustment invention.

FIG. 5 is a perspective view of the outer tubular component of the wheelchair adjuster.

FIG. 6 is a side view of the inner tubular component of the wheelchair adjuster.

FIG. 7 is a side view of the threaded compression fitting and U-shaped retention hook for attaching the inner tubular component to the lower wheelchair frame.

FIG. 8 is a side view of the threaded compression fitting and U-shaped retention hook for attaching the outer tubular component to the lower wheelchair frame.

FIG. 9 is a side view of the assembled wheelchair width adjuster revealing the length-locking button contained within the inner tubular component protruding through a perforation in the outer tubular component.

FIG. 10 is an expanded cross-sectional view of the snap button assembly housed in the inner tubular component under locking compression with buttons protruding from opposing perforations in the outer tubular component.

FIG. 11 is an expanded view of the snap button assembly.

FIG. 12 is a frontal view of a standard folding wheelchair at its full extension.

FIG. 13 is a frontal view of a standard folding wheelchair locked into a narrower width position after attachment of the width adjusting invention herein described.

### DETAILED DESCRIPTION OF THE INVENTION

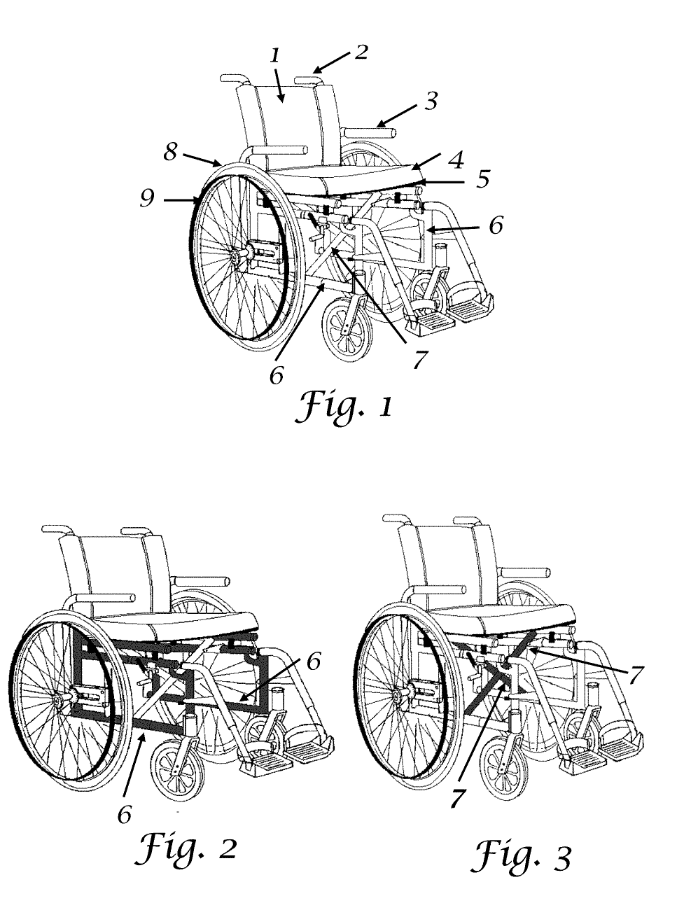

Examining the drawings in detail, FIG. 1 illustrates several components of a typical folding wheelchair, including the back support 1, push handle 2, padded armrest 3, seat cushion 4, seat sling 5, right and left rigid frames 6, x-shaped cross brace 7, pneumatic tire attached to frame 8, and hand rim for propelling chair 9. For a more complete description of all the components of a typical manual folding wheel wheelchair see reference cited by Dr. D. Michael McKeough (2007) who granted permission to use figures from his publication as FIG. 1, FIG. 2, and FIG. 3 in this application. For purposes of this application, the most critical elements are shown shaded for clarity in FIG. 2 and FIG. 3, i.e. the rigid side frames 6 in FIG. 2 and the x-shaped cross brace 7 that connects the frames in FIG. 3. Most attempts to modify the basic design of a folding wheelchair to narrow its width to permit passage through a narrow doorway have focused on alterations to the side frames or the x-shaped cross brace as previously discussed in the BACKGROUND OF THE INVENTION section.

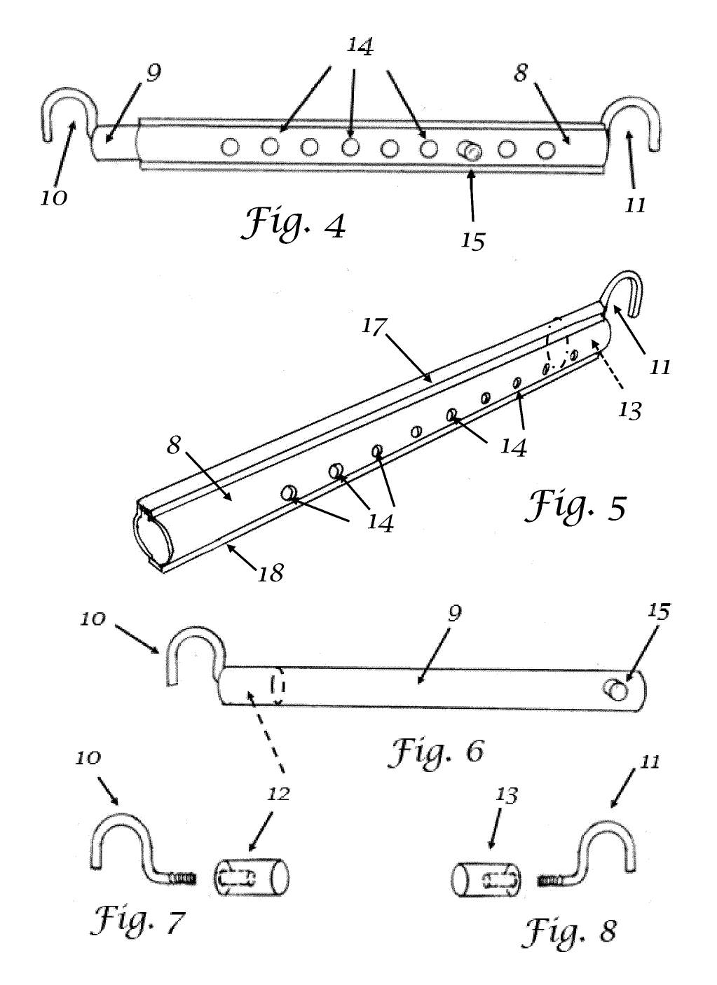

FIG. 4 represents a frontal view of the assembled device proposed in this patent application. The two primary telescoping components include an outer tubular element 8 and an inner tubular element 9. U-shaped supports for attaching the device to the lower parts of the rigid cross braces FIG. 3. are firmly attached to the ends of the inner tubular element 10 as well as the outer tubular element 11. The outer tubular element 8 contains numerous perforations along its length 14 that correspond to matching perforations 14 on the opposite side of the tubular element 8. One of the two complementary snap buttons is shown protruding from one of the perforations 15.

A more detailed perspective drawing of the outer tubular element 8 is shown in FIG. 5. While a perfectly circular tubular outer element may be adequate in most applications for this device, an optional embodiment is modifying the top 17 and bottom 18 of the outer tubular element 8 to include axially-incised ridges that strengthen the outer tubular structure 8. By depressing the snap buttons 15 while holding firmly the outer tubular element 8 and twisting the inner tubular element 9 in FIG. 6 slightly, the snap buttons 15 are compressed against the inner wall of the outer tubular element 8 and can be easily slid into a new position. Once positioned at the appropriate perforation location for the desired length, the inner tubular structure 9 is rotated slightly until the snap buttons 15 engage the outer tubular perforations 14 and lock the device in place at the desired length.

At opposing ends of both the outer tubular element 8 and the inner tubular element 9 are U-shaped hooks 10 and 11 for attaching the device to the horizontal members of the wheelchair frames 6 in FIG. 2. The U-shaped hooks 10 and 11 may be attached to outer tubular element 8 and inner tubular element 9 in a variety of ways. One method is shown in FIG. 7 and FIG. 8 whereby threaded U-shaped hooks 10 and 11 are screwed into threaded plugs 12 and 13 that are held by compression in the ends of the outer tubular element 8 and the inner tubular element 9.

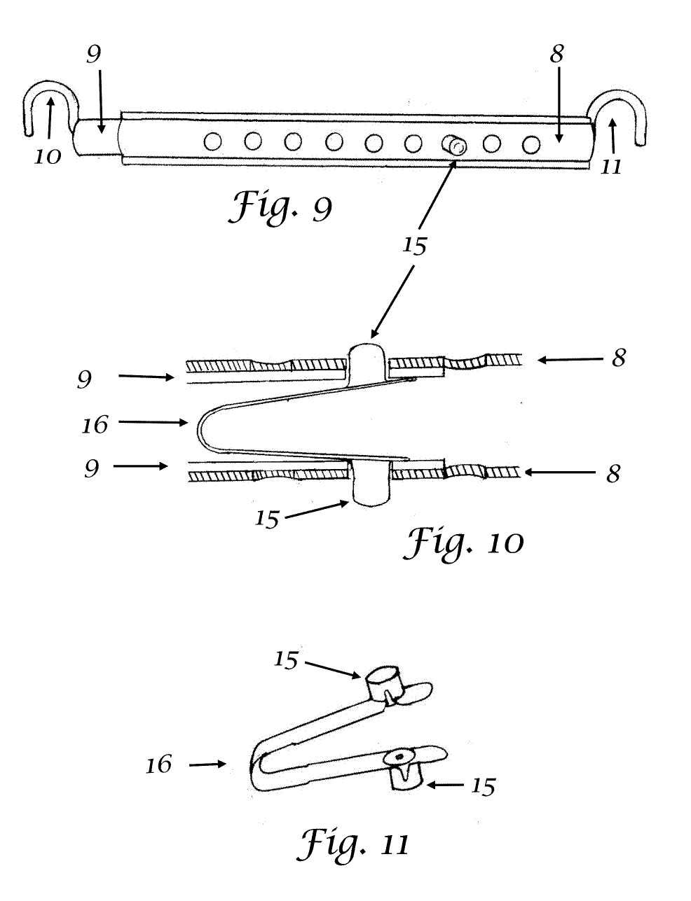

FIG. 9 shows the assembled elements of the adjusting device proposed herein, i.e. the outer tubular element 8 with its attached U-shaped hook 11, the inner tubular element 9 with its attached U-shaped hook 10, and the protruding snap button 15. FIG. 10 illustrates a longitudinal cross-sectional view of the snap button assembly 16 installed in tubular element 9 showing buttons 15 protruding through perforations in the outer tubular element 8 that serves to lock the adjusting device in its desired position.

FIG. 11 illustrates a perspective view of the uncompressed snap assembly spring 16 with its attached snap buttons 15 that is inserted into the end of inner tubular element 9 until it snaps into place through perforations near the end of inner tubular element 9.

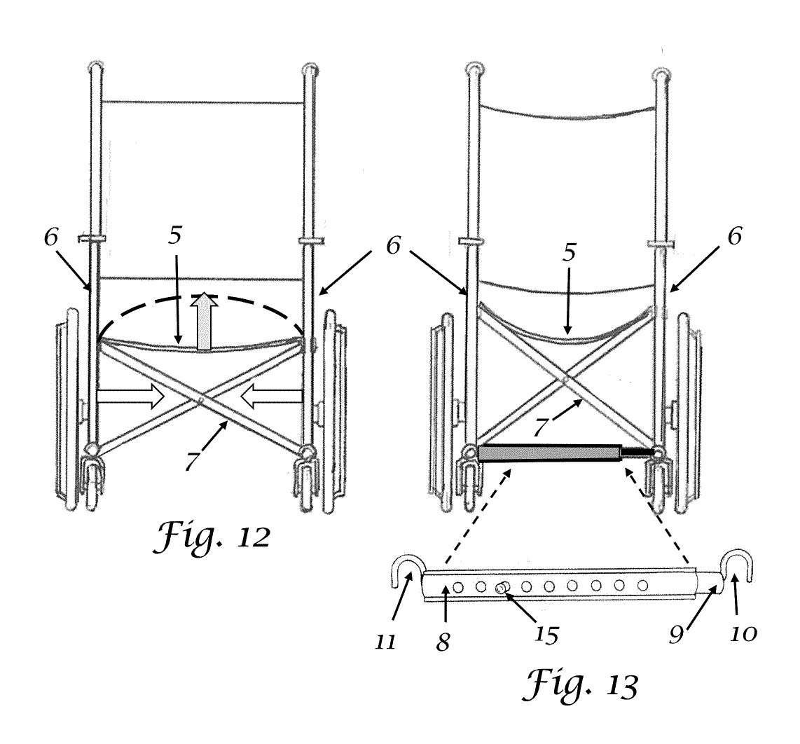

FIG. 12 illustrates a folding wheelchair with the sling seat 5 at its maximum width and the rigid side frames 6 at their fullest extension. When the sling seat 5 is raised (indicated by the shaded arrow) to a position represented by the dashed line, the rigid side frames 6 will be pulled towards one another (indicated by the open unfilled arrows) and the X-shaped cross brace will be compressed.

FIG. 13 illustrates the resultant configuration of a narrowed folding wheelchair. The sling seat 5 sags slightly downward as the overall profile of the folding chair is narrowed. Once the desired width is determined, the tubular adjustable device described herein containing components 8, 9, 10, 11, and 15 is adjusted in length to agree with the width desired and placed manually over the lowermost members of the frame to lock the width securely in place as shown by the simplified shaded device attached to the wheel chair in FIG. 13.

1. A relatively small, portable device that can be attached to a folding wheelchair to narrow its width by connecting the lower cross members of a wheelchair frame resulting in a configuration narrower than that produced when the wheelchair was manufactured.

2. A device that is manually adjustable using opposing snap buttons to provide variable widths for a folding wheelchair depending on the degree of narrowing that is required for a particular application.

3. (canceled)

4. (canceled)

5. A device that can be installed on an existing folding wheelchair manually without requiring the use of tools.

6. (canceled)

7. (canceled)

8. (canceled)

9. (canceled)

10. (canceled)
